(19) United States
(12) Patent Application Publication
(10) Pub. No.: US 2026/0328998 A1
(43) Pub. Date: Oct. 22, 2026

(54) THREE-DIMENSIONAL PHOTONIC INTERCONNECTS

(71) Applicant: Taiwan Semiconductor Manufacturing Company Limited, Hsinchu (TW)

(72) Inventors: Chen-Hua Yu, Hsinchu City (TW); Tung-Liang Shao, Hsinchu (TW)

(21) Appl. No.: 19/728,167

(22) Filed: Jul. 1, 2026

Related U.S. Application Data
(63) Continuation of application No. 18/512,077, filed on Nov. 17, 2023, now Pat. No. 12,724,195.

(51) Int. Cl. G02B 6/12; G02B 6/122; G02B 6/125

(52) U.S. Cl. CPC G02B 6/12002; G02B 6/122; G02B 6/125; G02B 2006/12061; G02B 2006/12104; G02B 2006/12147

(57) ABSTRACT

An embodiment photonic device may include a first photonic interconnect formed over a first horizontal plane, a second photonic interconnect formed over a second horizontal plane that is vertically displaced relative to the first horizontal plane, and a photonic coupler connected to the first photonic interconnect and the second photonic interconnect. The photonic coupler may be configured such that first photonic signals that are incident on the photonic coupler from the first photonic interconnect are directed by the photonic coupler into the second photonic interconnect, and second photonic signals that are incident on the photonic coupler from the second photonic interconnect are directed by the photonic coupler into the first photonic interconnect. The photonic coupler may further include a photonic via that connects the first photonic interconnect to the second photonic interconnect and that allows photonic signals to propagate between the first photonic interconnect and the second photonic interconnect.

### CROSS-REFERENCE TO RELATED APPLICATION

This application is a continuation of U.S. Patent Application No. 18/512,077, entitled “Three-Dimensional Photonic Interconnects,” filed Nov. 17, 2023, the entire contents of which are incorporated herein by reference for all purposes

### BACKGROUND

Many computing applications use optical (i.e., photonic) signals to provide secure high-speed data transmission. Various emerging technologies are also being developed that may provide functionality to perform computing operations directly on optical/photonic signals. Silicon photonics is a promising technology area that uses semiconductor device processing techniques to provide systems including integrated electronic and photonic components. Such components may be used for the generation, routing, modulation, processing, and detection of light. Together, these functions form an optical analog to electronic integrated circuits (IC) and, as such, may constitute photonic integrated circuits (PIC).

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic illustration of various components that may be used in a photonic computing system.

FIG. 2A is a top view of an electro-optic modulator that may be used in a photonic computing system.

FIG. 2B is a top view of an optical switch that may be used in a photonic computing system.

FIG. 2C is a vertical cross-sectional view of a silicon waveguide along a vertical plane C-C’ in FIGS. 2A and 2B.

FIG. 3A is three-dimensional perspective view of a photonic device that includes three-dimensional photonic interconnects, according to various embodiments.

FIG. 3B is top view of the photonic device of FIG. 3A, according to various embodiments.

FIG. 3C is side view of the photonic device of FIG. 3A, according to various embodiments.

FIG. 3D is a further side view of the photonic device of FIG. 3A, according to various embodiments.

FIG. 4A is a three-dimensional perspective view of a further photonic device that includes three-dimensional photonic interconnects, according to various embodiments.

FIG. 4B is a top view of the photonic device of FIG. 4A, according to various embodiments.

FIG. 4C is a side view of the photonic device of FIG. 4A, according to various embodiments.

FIG. 4D is a further side view of the photonic device of FIG. 4A, according to various embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Unless explicitly stated otherwise, each element having the same reference numeral is presumed to have the same material composition and to have a thickness within a same thickness range.

Photonic interconnects play an important role in photonic computing systems. Various embodiments disclosed herein may be advantageous by providing multi-directional, three-dimensional (3D), photonic interconnects. Such 3D photonic interconnects may allow formation of photonic integrated circuits having an increased integration density and may provide smaller devices with reduced optical insertion loss relative to systems that do not utilize 3D photonic interconnects.

An embodiment photonic device may include a first photonic interconnect formed over a first horizontal plane, a second photonic interconnect formed over a second horizontal plane that is vertically displaced relative to the first horizontal plane, and a photonic coupler connected to the first photonic interconnect and the second photonic interconnect. The photonic coupler may be configured such that first photonic signals that are incident on the photonic coupler from the first photonic interconnect are directed by the photonic coupler into the second photonic interconnect, and second photonic signals that are incident on the photonic coupler from the second photonic interconnect are directed by the photonic coupler into the first photonic interconnect. The photonic coupler may further include a photonic via that connects the first photonic interconnect to the second photonic interconnect and that allows photonic signals to propagate between the first photonic interconnect and the second photonic interconnect.

According to a further embodiment, a photonic device may include a first photonic interconnect including a first photonic propagation path and a second photonic propagation path, and a second photonic interconnect including a third photonic propagation path and a fourth photonic propagation path. The first photonic interconnect may be formed over a first horizontal plane and the second photonic interconnect may be formed over a second horizontal plane that is vertically displaced relative to the first horizontal plane. The photonic device may further include a photonic coupler that includes a first photonic via that connects the first photonic propagation path to the third photonic propagation path and a second photonic via that connects the second photonic propagation path to the fourth photonic propagation path.

According to a further embodiment, a photonic device may include a first photonic waveguide, having a first dielectric constant, formed within a first layer of a cladding material having a second dielectric constant that is less than the first dielectric constant. The photonic device may further include a second photonic waveguide, having the first dielectric constant, formed within a second layer of the cladding material, having the second dielectric constant that is less than the first dielectric constant. According to various embodiments, the second layer of the cladding material may be vertically displaced relative to the first layer of the cladding material. The photonic device may further include a photonic via formed within a third layer of the cladding material such that the photonic via photonically couples the first photonic waveguide and the second photonic waveguide. Further, the third layer of the cladding material may be formed such as to separate the first layer of the cladding material and the second layer of the cladding material.

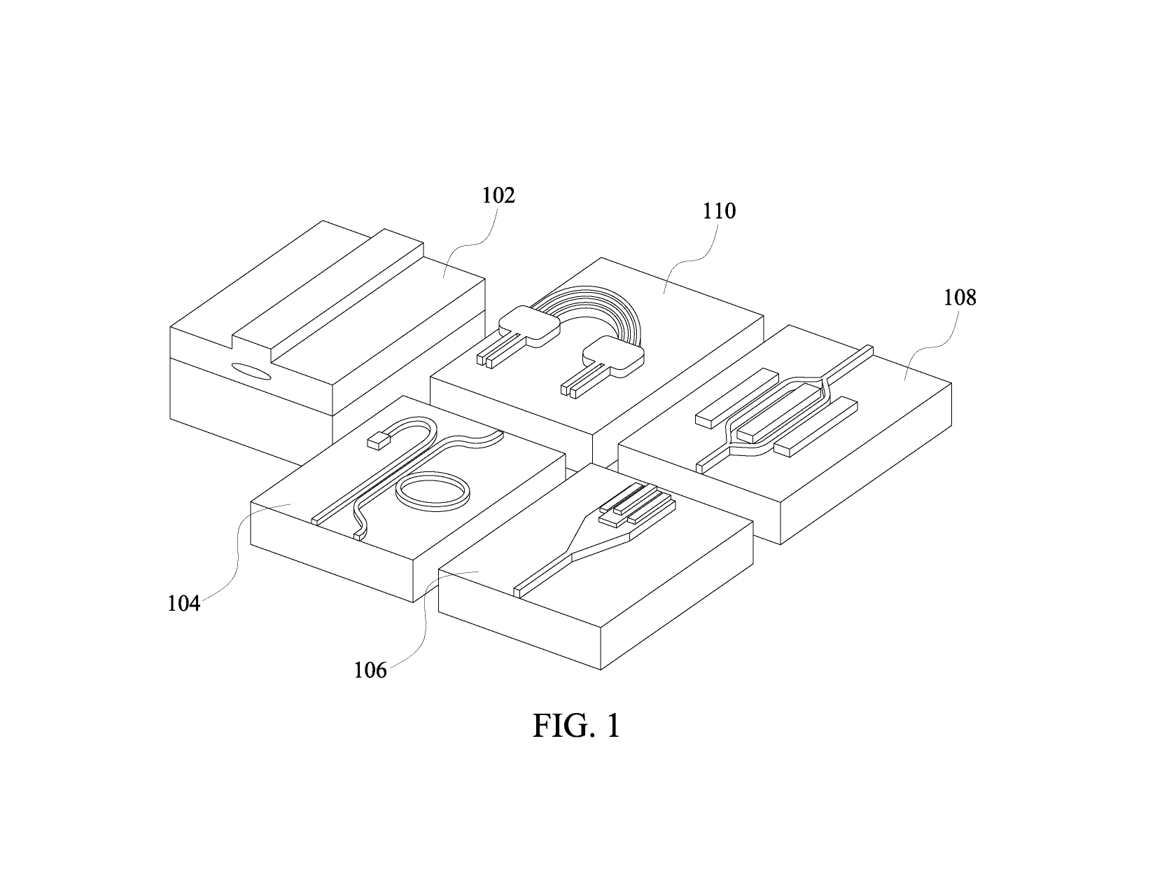

FIG. 1 is an illustration of various components that may be used in a photonic computing system. System components may include a generation device also referred to as a photonic source 102 such as a laser or light-emitting diode (LED), a routing device that may include a plurality of waveguides 104 configured to route optical signals, and a detector that includes one or more optical/photonic detectors 106 configured to detect optical/photonic signals and to convert received optical/photonic signals into output electrical signals. Additional components may include a modulation device that includes one or more optical modulators 108 and photonic processing components 110. The one or more optical modulators 108 may be configured to impose an amplitude and/or phase modulation on an input optical signal generated by the photonic source 102. The photonic processing components 110 may be configured to perform logic operations on the modulated optical signal. The one or more optical modulators 108 may take an input electronic signal and modulate the input optical signal to impose an amplitude and/or phase modulation in response to the input electronic signal. In this way, the one or more optical modulators 108 may be used to convert data provided in the form of an electronic signal into data encoded as a photonic signal. Similarly, the one or more optical detectors 106 may convert processed photonic signals back into output electrical signals.

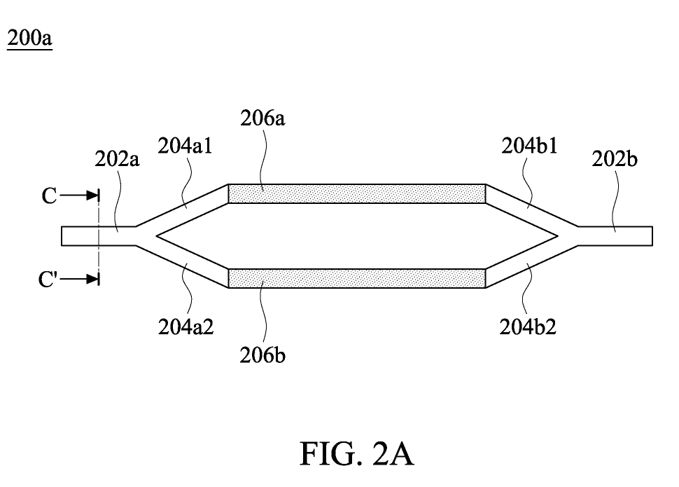

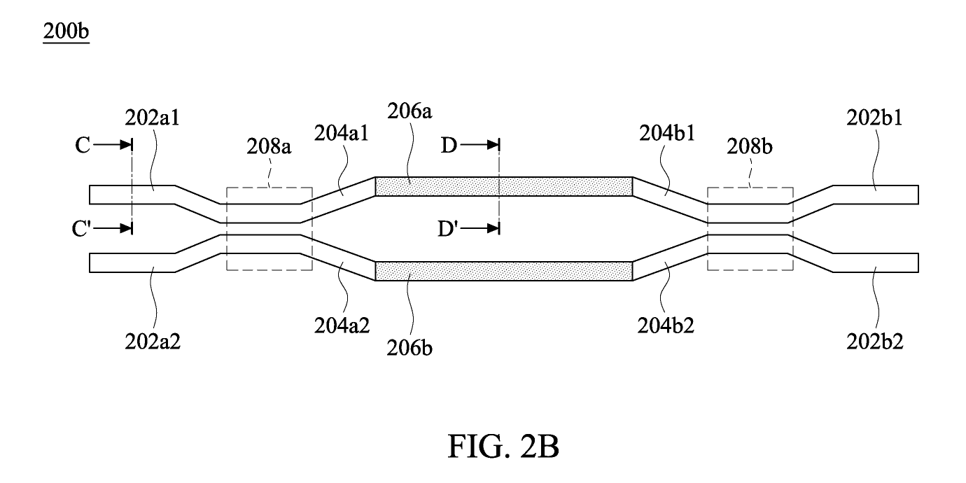

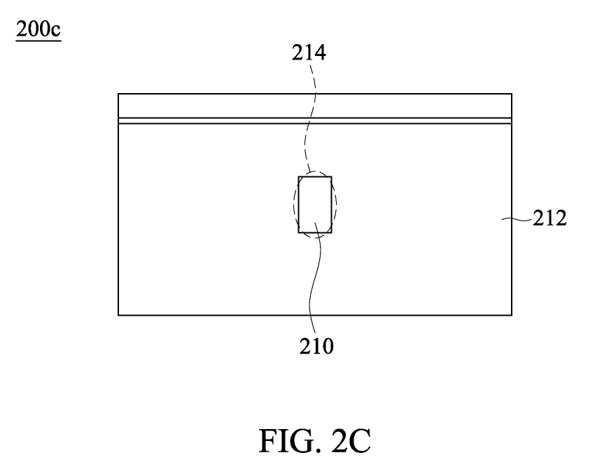

FIG. 2A is a top view of an electro-optic modulator 200a that may be used in a photonic computing system. The cross-section C – C’ indicates a vertical plane defining the vertical cross-sectional view shown in FIG. 2C. The electro-optic modulator 200a may include an input waveguide 202a and an output waveguide 202b. The input waveguide 202a may be configured to receive an input optical signal and the output waveguide 202b may be configured to provide an output signal that is a modulated version of the input optical signal. As shown, the input waveguide 202a may branch into a first waveguide segment 204a1 and a second waveguide segment 204a2. As such, the input waveguide 202a, the first waveguide segment 204a1, and the second waveguide segment 204a2 may act as a beam splitter.

An input signal received by the input waveguide 202a may be split into two optical signals (i.e., two copies of the input optical signal) that may be carried by the first waveguide segment 204a1 and the second waveguide segment 204a2, respectively. A first optical signal carried by the first waveguide segment 204a1 may be provided to a first modulator portion 206a and a second optical signal carried by the second waveguide segment 204a2 may be provided to a second modulator portion 206b. The first modulator portion 206a and the second modulator portion 206b may modify an amplitude and/or a phase of the respective first optical signal and the second optical signal.

The modified first optical signal transmitted along a third waveguide segment 204b1 and the modified second optical signal transmitted along a fourth waveguide segment 204b2 may then be combined to form an output optical signal that is provided to the output waveguide 202b. In this regard, the third waveguide segment 204b1 may be optically coupled to the first modulator portion 206a and the fourth waveguide segment 204b2 may be optically coupled to the second modulator portion 206b. In turn, the third waveguide segment 204b1 and the fourth waveguide segment 204b2 may be optically coupled to the output waveguide 202b. As such, the third waveguide segment 204b1, the fourth waveguide segment 204b2, and the output waveguide 202b may act as a beam combiner. The first modulator portion 206a and the second modulator portion 206b may each modulate the respective first optical signal and the second optical signal according to an electro-optic effect. In this regard, the first modulator portion 206a and the second modulator portion 206b may each include a material having electro-optic properties. Such an electro-optic material may have optical properties (e.g., index of refraction and absorption coefficient) that may vary as a function of an applied electrical bias (i.e., voltage difference).

FIG. 2B is a top view of an optical switch 200b that may be used in a photonic computing system. The cross-section C – C’ indicates a vertical plane defining the vertical cross-sectional view shown in FIG. 2C. The optical switch 200b may include a first input waveguide 202a1, a second input waveguide 202a2, a first output waveguide 202b1, and a second output waveguide 202b2. Each of the first input waveguide 202a1, the second input waveguide 202a2, the first output waveguide 202b1, and the second output waveguide 202b2 may be configured to support single mode or multimode optical beams carrying optical signals. In an example embodiment, the optical switch 200b may be implemented as a Mach-Zehnder interferometer integrated with a first 50/50 beam splitter 208a and a second 50/50 beam splitter 208b. As shown in FIG. 2B, each of the first input waveguide 202a1 and the second input waveguide 202a2 may be optically coupled to the first 50/50 beam splitter 208a (also referred to as a directional coupler). The first 50/50 beam splitter 208a may receive a first optical signal from the first input waveguide 202a1 and a second input signal from the second input waveguide 202a2.

Through the phenomena of evanescent coupling, a first 50% of the first optical signal may be directed into the first waveguide segment 204a1 and a second 50% of the first optical signal may be directed to the second waveguide segment 204a2. Concurrently, a first 50% of the second optical signal may be directed into the first waveguide segment 204a1 and a second 50% of the second optical signal may be directed to the second waveguide segment 204a2. In this regard, the first optical signal and the second optical signal may be evenly split between the first waveguide segment 204a1 and the second waveguide segment 204a2.

The first modulator portion 206a and the second modulator portion 206b may receive signals from the first waveguide segment 204a1 and the second waveguide segment 204a2, respectively, and may act to adjust amplitudes and/or phases of the received signals. In this regard, each of the first modulator portion 206a and the second modulator portion 206b may include an electro-optic material having optical properties (e.g., index of refraction and absorption coefficient) that may vary as a function of an applied electrical bias. As such, in certain embodiments, phases of optical signals propagating with the first modulator portion 206a and the second modulator portion 206b may be controllably varied through application of pre-determined bias potentials.

After propagation through the first 50/50 beam splitter 208a, signals propagating in the first waveguide segment 204a1 and the second waveguide segment 204a2 may have a well-defined phase relationship (e.g., in-phase, 180° out-of-phase, etc.) relative to one another. As such, the first modulator portion 206a and the second modulator portion 206b may introduce a pre-determined phase difference between signals respectively received from the first waveguide segment 204a1 and the second waveguide segment 204a2. Signals propagating through the first modulator portion 206a may then be provided as output to a third waveguide segment 204b1 and signals propagating through the second modulator portion 206b may be provided as output to a fourth waveguide segment 204b2. Respective signals received from the third waveguide segment 204b1 and the fourth waveguide segment 204b2 may then be provided to the second 50/50 beam splitter 208b.

The second 50/50 beam splitter 208b may then act to send a first 50% of the signal received from the third waveguide segment 204b1 to the first output waveguide 202b1 and a second 50% of the signal received from the third waveguide segment 204b1 to the second output waveguide 202b2. Concurrently, a first 50% of the signal received from the fourth waveguide segment 204b2 may be sent to the first output waveguide 202b1 and a second 50% of the signal received from the fourth waveguide segment 204b2 may be sent to the second output waveguide 202b2.

The relative phase between the signals propagating in the third waveguide segment 204b1 and the fourth waveguide segment 204b2 may determine what signals appear in the first output waveguide 202b1 and the second output waveguide 202b2. Due to the phenomena of constructive and destructive interference, signals may be switched such that a signal only appears in the first output waveguide 202b1 (e.g., light beams may be in-phase) or in second output waveguide 202b2 (e.g., light beams may be out of phase). As such, by applying certain predetermined bias voltages to the first modulator portion 206a and the second modulator portion 206b, the optical switch 200b may provide switch functionality in that optical signals may be directed to either the first output waveguide 202b1 or to the second optical waveguide 202b2 as a function of bias voltages applied to the first modulator portion 206a and the second modulator portion 206b. Although both arms of the optical switch 200b (configured as a Mach-Zehnder interferometer in this example embodiment) are illustrated as including phase adjustment sections (i.e., the first modulator portion 206a and the second modulator portion 206b) other embodiments may include an optical switch 200b having a phase adjustment device in only a single arm.

Although a Mach-Zehnder interferometer implementation is illustrated in FIG. 2B as the optical switch 200b, embodiments may not be limited to this particular switch architecture. Various other phase adjustment devices may be included within the scope of this disclosure, including ring resonator designs, Mach-Zehnder modulators, generalized Mach-Zehnder modulators, etc. In some embodiments, optical phase shifter devices described herein may be utilized within a quantum computing system. Alternatively, such optical phase shifter devices may be used in other types of optical systems. For example, other computational, communication, and/or technological systems may utilize photonic phase shifters to direct optical signals (e.g., single photons or continuous wave (CW) optical signals) within a system or network, and phase shifter architectures described herein may be used within these systems, in various embodiments.

FIG. 2C is a vertical cross-sectional view of a dielectric (e.g., silicon/SiO₂) waveguide 200c. As mentioned above, the vertical plane defining the view illustrated in FIG. 2C is indicated by the cross-section C – C’ in FIGS. 2A and 2B. The dielectric waveguide 200c may include a core portion 210 and a cladding portion 212. The core portion 210 and the cladding portion 212 may each be configured to be transparent to light of a particular wavelength (e.g., infrared radiation). The core portion 210 and the cladding portion 212 may be formed using semiconductor device fabrication processes, as described in greater detail below.

The core portion 210 may be configured to have a higher index of refraction than that of the cladding portion 212. For example, the core portion 210 may be formed of doped or undoped silicon (e.g., index of refraction 3.88) and the cladding portion 212 may be formed of silicon oxide (e.g., index of refraction 1.46). Light may preferentially propagate in the core portion 210 due to the phenomena of total internal reflection resulting from the higher index of refraction of the core portion 210 relative to the cladding portion 212. For example, an optical mode may propagate within the core portion 210 and may have an electric field distribution that is confined to a localized region 214 associated with the core portion 210. The specific shape of the core portion 210 shown in FIG. 2C is merely an example and the core portion 210 may have various other shapes in other applications.

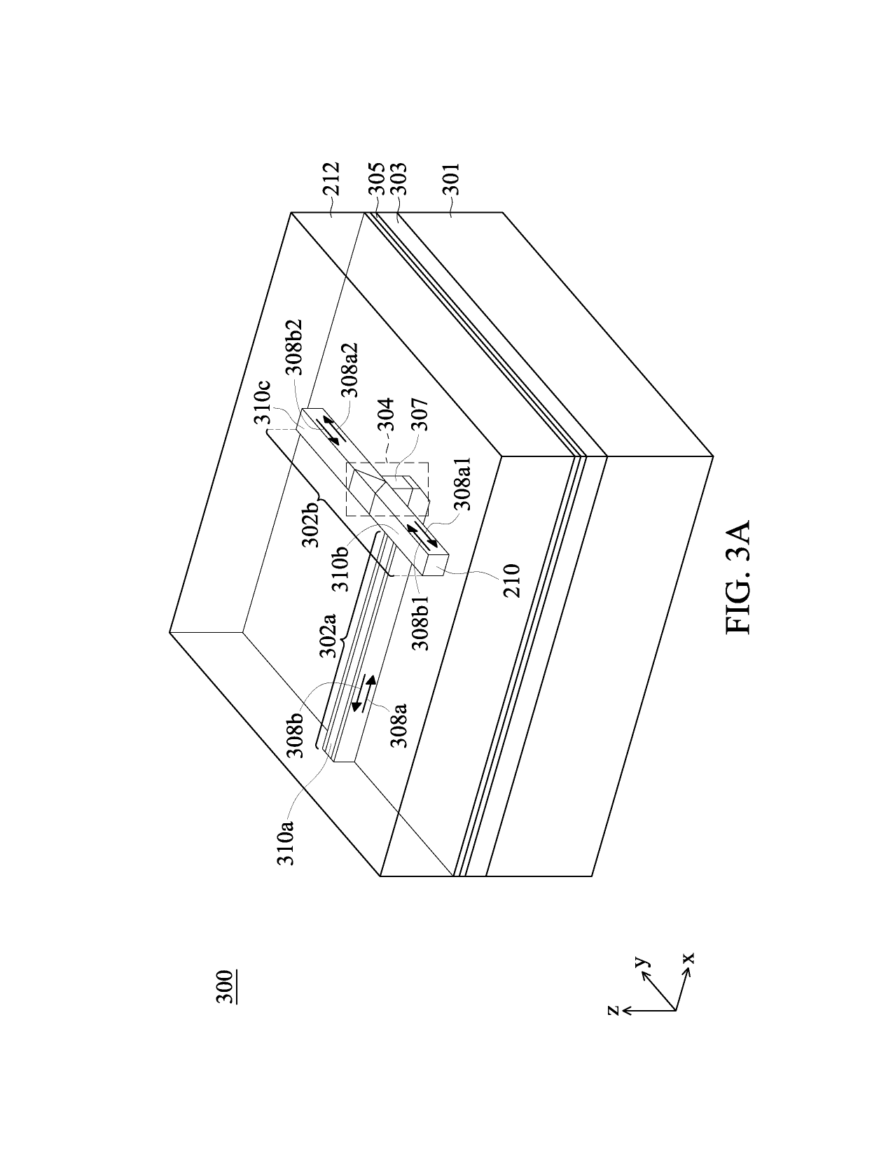

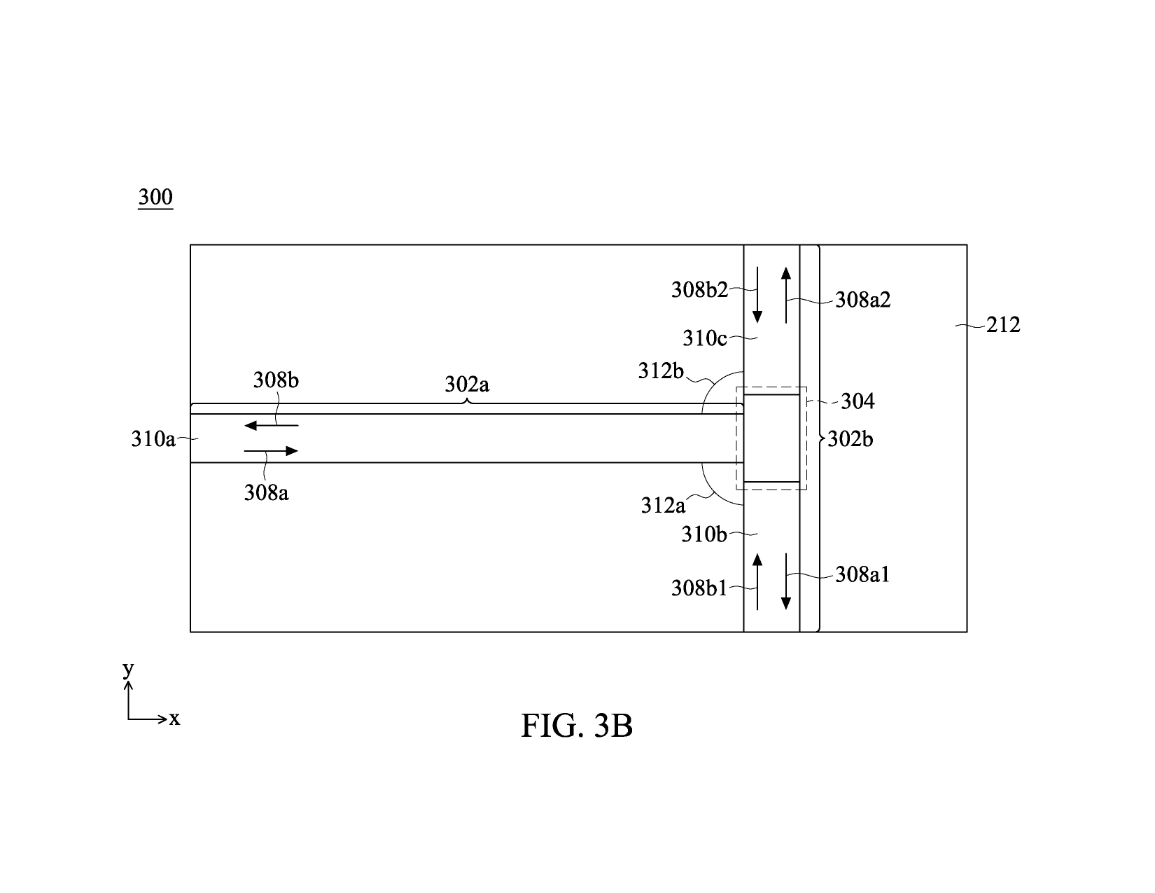

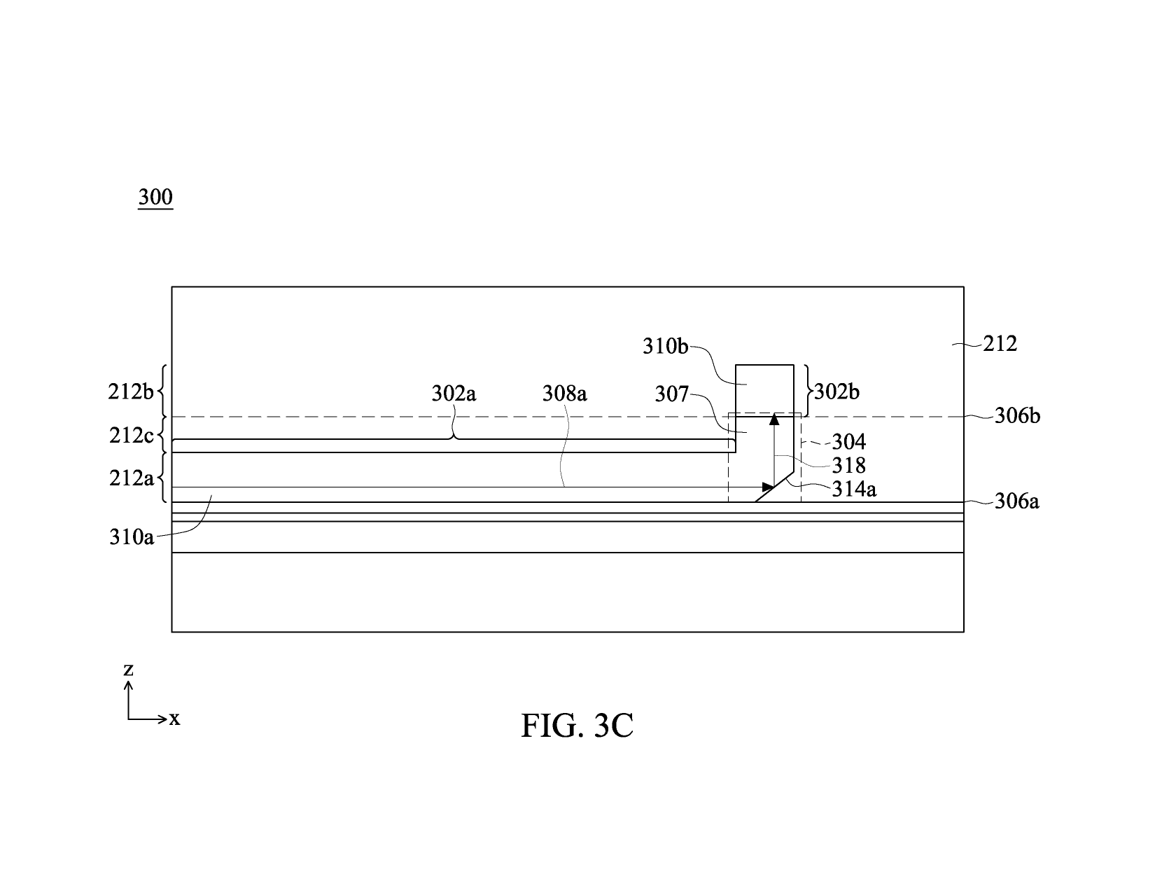

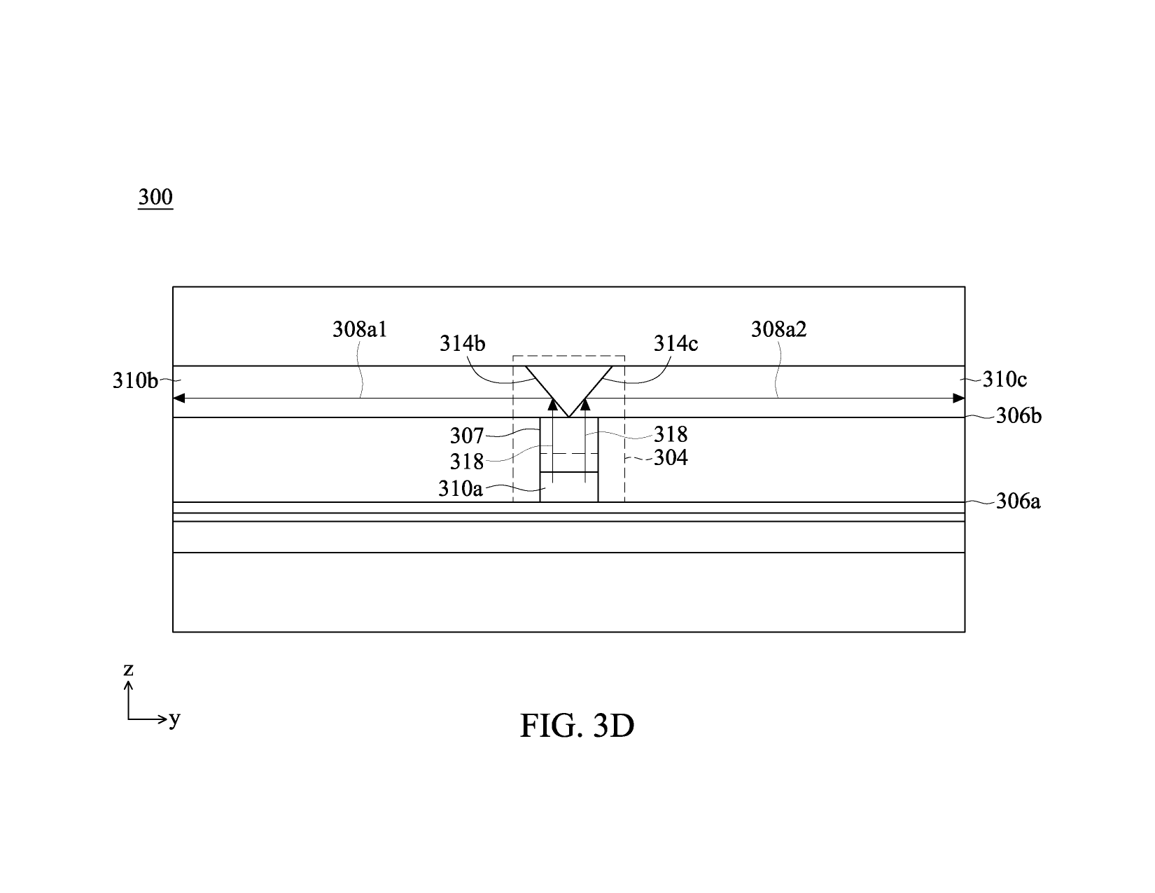

FIG. 3A is a three-dimensional perspective view of an embodiment photonic device 300 including three-dimensional photonic interconnects (302a, 302b), according to various embodiments. With reference to FIGS. 3A-3D, the photonic device 300 may include a first photonic interconnect 302a formed over a first horizontal plane 306a (e.g., see FIG. 3C) and a second photonic interconnect 302b formed over a second horizontal plane 306b (e.g., see FIG. 3C). As shown in FIG. 3C, the second horizontal plane 306b may be vertically displaced relative to the first horizontal plane 306a. The photonic device 300 may further include a photonic coupler 304 connected to the first photonic interconnect 302a and the second photonic interconnect 302b. The photonic coupler 304 may further include a photonic via 307 that connects the first photonic interconnect 302a to the second photonic interconnect 302b as described in greater detail with reference to FIG. 3C, below.

Each of the first photonic interconnect 302a and the second photonic interconnect 302b may be configured to allow propagation of an optical (i.e., photonic) mode. For example, each of the first photonic interconnect 302a and the second photonic interconnect 302b may be configured as a dielectric waveguide 200c (e.g., see FIG. 2C) having a core portion 210 that has a first dielectric constant surrounded by a cladding material 212 having a second dielectric constant that is less than the first dielectric constant.

The photonic device 300 may be formed using semiconductor manufacturing processes. For example, the photonic device 300 may be formed as part of a multi-layer structure including several material layers. For example, the multi-layer structure may include a silicon-on-insulator substrate including a silicon layer 301, and oxide layer 303 formed over the silicon layer 301, and a silicon device layer 305 formed over the oxide layer 303. The first photonic interconnect 302a and the second photonic interconnect 302b may be formed by deposition and patterning of various dielectric layers. For example, in various embodiments, each of the first photonic interconnect 302a and the second photonic interconnect 302b may be formed as silicon waveguides having a silicon core portion 210 surrounded by a silicon oxide cladding material 212. Various other materials may be used for the first photonic interconnect 302a and the second photonic interconnect 302b in other embodiments. For example, in various embodiments, the first photonic interconnect 302a and the second photonic interconnect 302b may each be formed of one of Si, SiN, LiNbO₃, BaTiO₃, a polymer material, etc.

FIG. 3B is top view of the photonic device 300 of FIG. 3A, according to various embodiments. As shown in FIGS. 3A and 3B, the photonic coupler 304 may be configured such that first photonic signals 308a that are incident on the photonic coupler 304 from the first photonic interconnect 302a may be directed by the photonic coupler 304 into the second photonic interconnect 302b. Similarly, second photonic signals (308b1, 308b2) that are incident on the photonic coupler 304 from the second photonic interconnect 302b may be directed by the photonic coupler 304 into the first photonic interconnect 302a. In this regard, the photonic device 300 of FIGS. 3A and 3B may be configured as a beam splitter in which the first photonic signal 308a (i.e., an input signal) may be split into two output signals (308a1, 308a2). Similarly, the photonic device 300 may function as a beam combiner in which two input signals (308b1, 308b2) may be combined into a single output signal 308b. In this regard, the first photonic interconnect 302a may include a first photonic propagation path 310a (e.g., a first dielectric waveguide 200c) and the second photonic interconnect 302b may include a second photonic propagation path 310b (e.g., a second dielectric waveguide 200c) and a third photonic propagation path 310c (e.g., a third dielectric waveguide 200c).

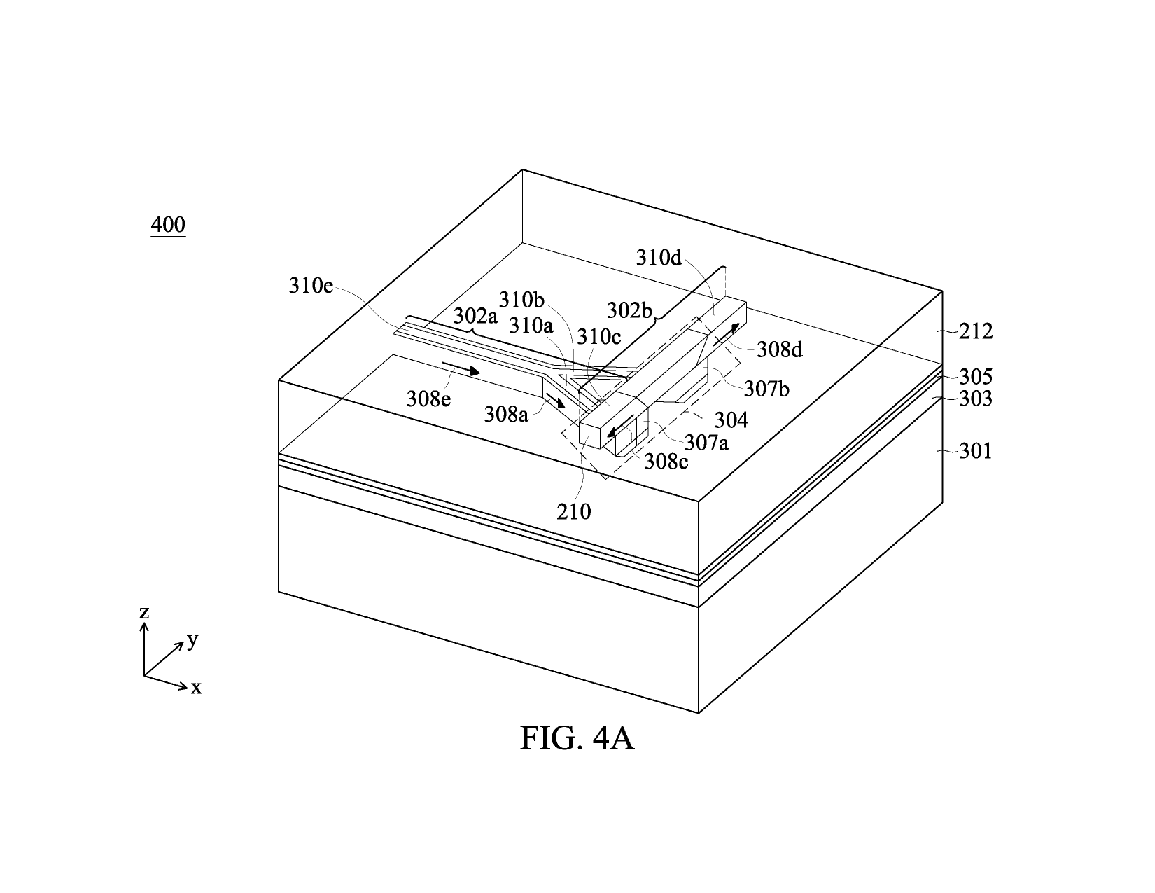

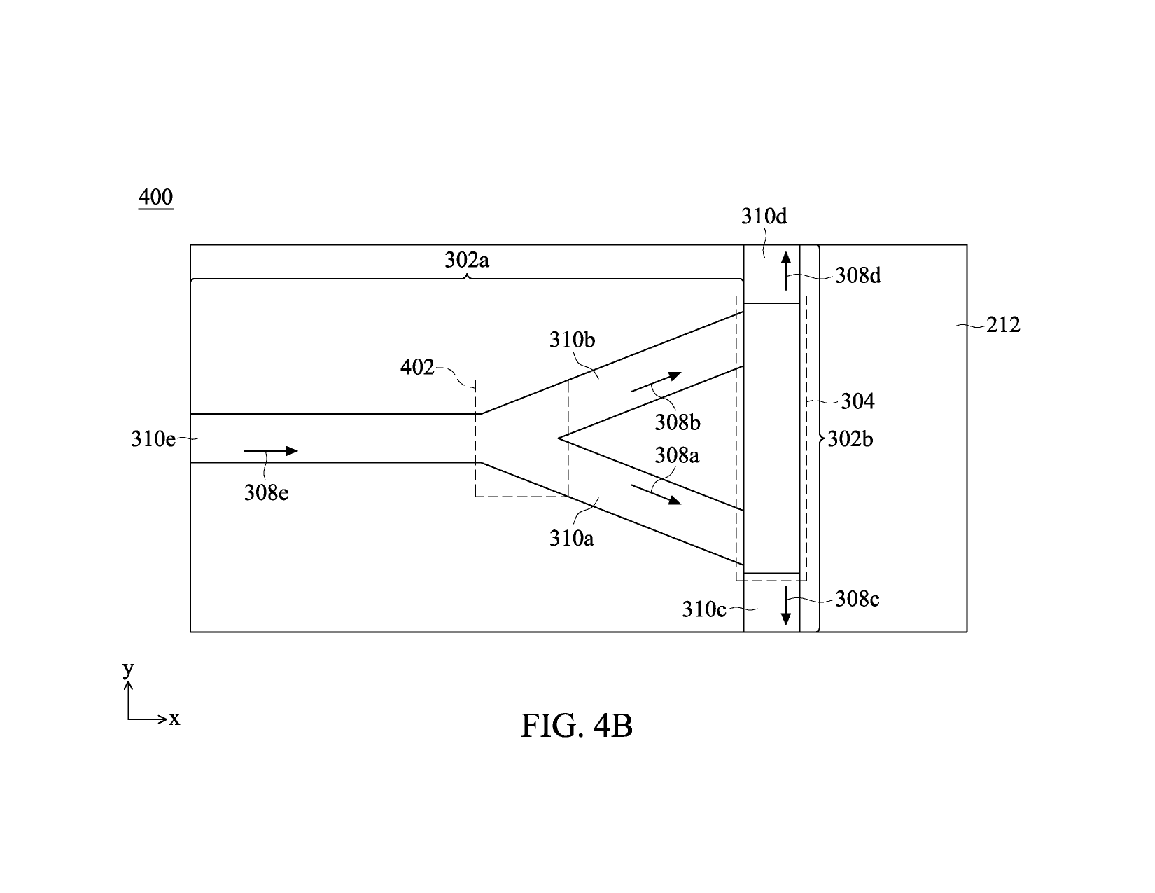

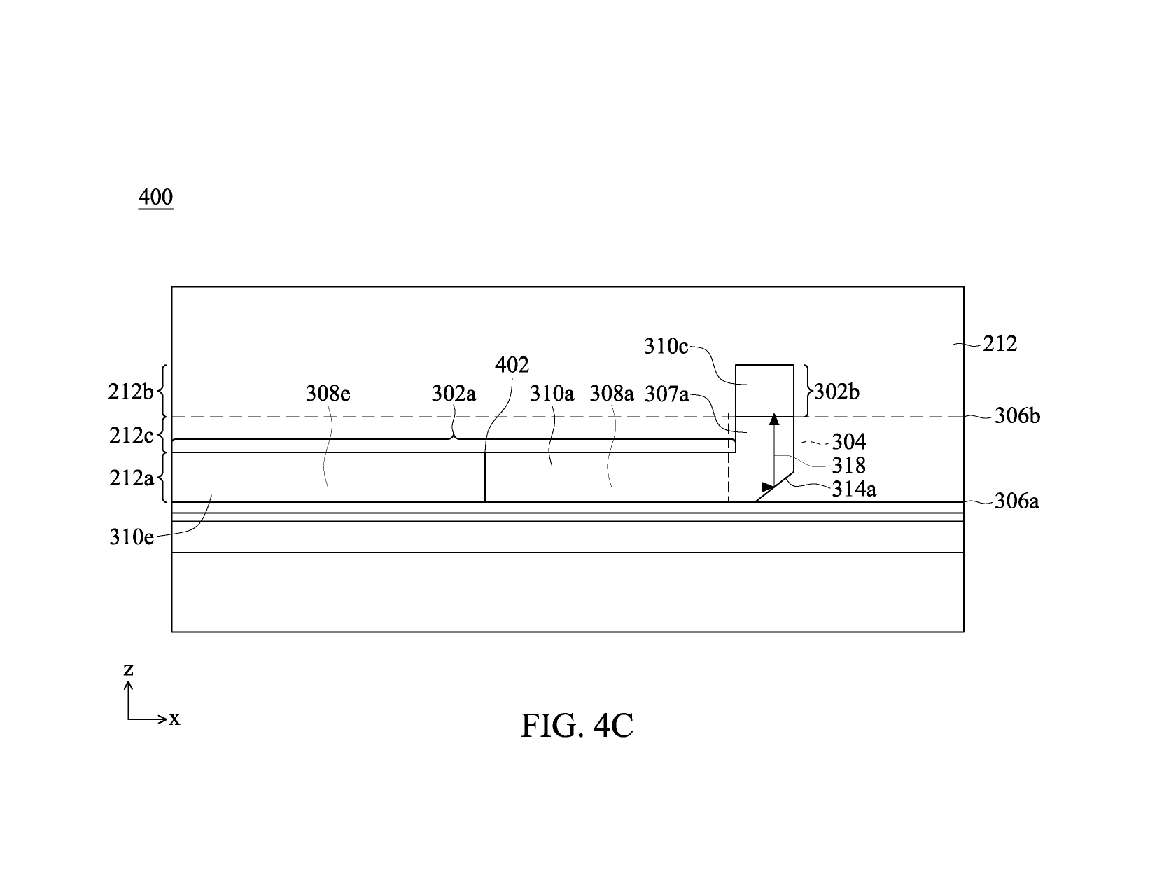

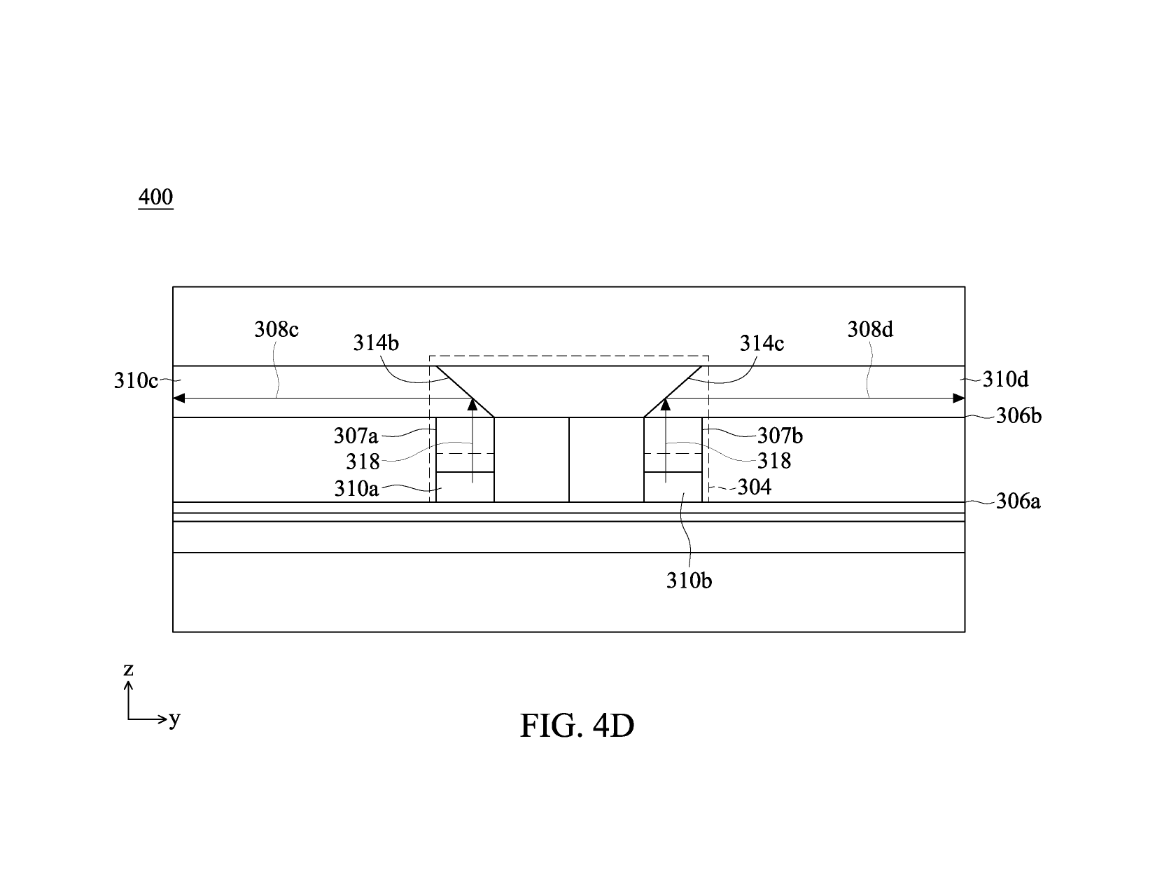

Each of the first photonic interconnect 302a and the second photonic interconnect 302b may have various numbers of photonic propagation paths in other embodiments. For example, in other embodiments, the first photonic interconnect 302a may include a first photonic propagation path 310a and the second photonic interconnect 302b may include a single photonic propagation path 310b. Alternatively, the first photonic interconnect 302a may include two photonic propagation paths and the second photonic interconnect 302b may also have two photonic propagation paths, as described in greater detail with reference to FIGS. 4A to 4E, below. In further embodiments, the first photonic interconnect 302a may have a first number N of photonic propagation paths and the second photonic interconnect 302b may have a second number M of photonic propagation paths, where N = 1, 2, 3..., and M = 1, 2, 3..., may take integer values.

As shown in FIG. 3B, the first photonic propagation path 310a may be oriented along a first direction (e.g., along the positive x-axis), the second photonic propagation path 310b may be oriented along a second direction (e.g., along the negative y-axis), and the third photonic propagation path 310c may be oriented along a third direction (e.g., along the positive y-axis). As such, the second direction may be oriented at a first angle 312a relative to the first direction and the third direction may be oriented at a second angle 312b relative to the first direction. In the example embodiment photonic device 300 of FIG. 3B, each of the first angle 312a and the second angle 312b may have a value of 90°. In various other embodiments, however, each of the first angle 312a and the second angle 312b may take any value that is between 0° and 180°.

FIG. 3C is side view of the photonic device 300 of FIG. 3A, according to various embodiments. The illustration of FIG. 3C corresponds to viewing the photonic device 300 along the positive y-axis (e.g., see FIG. 3A). As shown, the first photonic interconnect 302a may be formed in a first layer 212a of the cladding material 212 and the second photonic interconnect 302b may be formed in a second layer 212b of the cladding material 212. Similarly, the photonic via 307 may be formed in a third layer 212cof the cladding material 212, as described in greater detail below. As further shown in FIG. 3C, the photonic coupler 304 may include a first angled reflector 314a that is configured to receive a first horizontally propagating photonic signal (i.e., the first photonic signal 308a) and to convert the first horizontally propagating photonic signal 308a into a vertically propagating photonic signal 318 that propagates within the photonic via 307.

As shown, the first angled reflector 314a may include a planar surface that is angled relative to the first direction (i.e., the x-direction) and a fourth direction (i.e., the z-direction). In various embodiments, the angled reflector 314a may be formed at an interface between the core portion 210 and the cladding material 212 and may act to reflect photonic signals due to the phenomena of total internal reflection. In other embodiments, the angled reflector 314a may further be formed of a metal layer (not shown) or a multi-layer dielectric structure (also not shown) including one of alternating Si/SiO₂ layers, alternating SiN/SiO₂ layers, or alternating Ta₂O₅/SiO₂ layers. One or more additional angled reflectors (314b, 314c) may then convert the vertically propagating photonic signal 318 into one or more respective additional horizontally propagating photonic signals (308a1, 308a2) as described in greater detail with reference to FIG. 3D, below. In this regard, each of the additional angled reflectors (314b, 314c) may be a planar surface that is angled relative to the first direction (i.e., the x-direction) and the fourth direction (i.e., the z-direction) as shown in FIG. 3D.

FIG. 3D is a further side view of the photonic device of FIG. 3A, according to various embodiments. The illustration of FIG. 3D corresponds to viewing the photonic device 300 along the negative x-axis (e.g., see FIG. 3A). As shown in FIG. 3D, the photonic coupler 304 may include a second angled reflector 314bthat converts a first portion of the vertically propagating photonic signal 318 into a second horizontally propagating photonic signal (i.e., the first output signal 308a1) that may then be provided to the second photonic propagation path 310b. Similarly, the photonic coupler 304 may include a third angled reflector 314c that converts a second portion of the vertically propagating photonic signal 318 into a third horizontally propagating photonic signal (i.e., the second output signal 308a2) that may then be provided to the third photonic propagation path 310c.

In various embodiments, the angled reflectors (314a, 314b, 314c) may be formed at respective interfaces between the core portion 210 and the cladding material 212 and may act to reflect photonic signals due to the phenomena of total internal reflection. In other embodiments, one or more of the angled reflectors (314a, 314b, 314c) may further be formed of a metal layer (not shown) or a multi-layer dielectric structure (also not shown) including one of alternating Si/SiO₂ layers, alternating SiN/SiO₂ layers, or alternating Ta₂O₅/SiO₂ layers. Due to the geometry of the angled reflectors (314a, 314b, 314c), the photonic coupler 304 may also receive input signals (308b1, 308b2) from the second photonic interconnect 302b and may convert the input signals (308b1, 308b2) into a single output signal 308b, as described above with reference to FIG. 3B.

As illustrated in FIGS. 3C and 3D, the first horizontally propagating photonic signal 308a may be received from the first photonic propagation path 310a by the photonic coupler 304. The photonic coupler 304 may then convert the first horizontally propagating photonic signal 308a into the vertically propagating photonic signal 318, which may then be converted into the second horizontally propagating photonic signal 308a1 and the third horizontally propagating photonic signal 308a2. As shown in FIG. 3D, the second horizontally propagating photonic signal 308a1 may be provided by the photonic coupler 304 to the second photonic propagation path 310b and the third horizontally propagating photonic signal 308a2 may be provided by the photonic coupler 304 to the third photonic propagation path 310c. As such, the first horizontally propagating photonic signal 308a may be divided into two output signals (308a1, 308a2). Due to energy conservation, each of the output signals (308a1, 308a2) may have an intensity that is approximately half of an intensity of the input photonic signal 308a.

In certain embodiments, photonic coupler 304 may further include a photonic gain medium (not shown) that may act to increase respective intensities of the second horizontally propagating photonic signal 308a1 and the third horizontally propagating photonic signal 308a2. For example, the photonic coupler 304 may be formed of a dielectric material that may be doped with erbium or other material that may exhibit optical fluorescent properties. Similarly, one or more of the second photonic propagation path 310b and the third photonic propagation path 310c may include a photonic gain medium that may act to increase respective intensities of the second horizontally propagating photonic signal 308a1 and the third horizontally propagating photonic signal 308a2 in various embodiments.

FIG. 4A is a three-dimensional perspective view of a further embodiment photonic device 400 including three-dimensional photonic interconnects (302a, 302b), according to various embodiments. With reference to FIGS. 4A-4D, the photonic device 400 may include a first photonic interconnect 302a formed over a first horizontal plane 306a (e.g., see FIG. 4C) and a second photonic interconnect 302b formed over a second horizontal plane 306b (e.g., see FIG. 4C). As shown in FIG. 4C, the second horizontal plane 306b may be vertically displaced relative to the first horizontal plane 306a. The photonic device 400 may further include a photonic coupler 304 connected to the first photonic interconnect 302a and the second photonic interconnect 302b.

The first photonic interconnect 302a may include a first photonic propagation path 310a and a second photonic propagation path 310b (e.g., see FIG. 4A). Similarly, the second photonic interconnect 302b may include a third photonic propagation path 310c and a fourth photonic propagation path 310d. The photonic coupler 304 may include a first photonic via 307a, which connects the first photonic propagation path 310a to the third photonic propagation path 310c, and a second photonic via 307b, which connects the second photonic propagation path 310b to the fourth photonic propagation path 310d.

FIG. 4B is top view of the photonic device 400 of FIG. 4A, according to various embodiments. As shown in FIGS. 4A and 4B, the photonic coupler 304 may be configured such that input photonic signals (308a, 308b) that are incident on the photonic coupler 304 from the first photonic interconnect 302a may be directed by the photonic coupler 304 into the second photonic interconnect 302b as output photonic signals (308c, 308d). As shown in FIG. 4B the first photonic interconnect 302a may further include a fifth photonic propagation path 310e connected to the first photonic propagation path 310a and the second photonic propagation path 310b at a junction 402. The junction 402 may be formed such that an input photonic signal 308e traveling within the fifth photonic propagation path 310e toward the junction 402 is split into a first photonic signal 308a propagating away from the junction 402 within the first photonic propagation path 310a and a second photonic signal 308b propagating away from the junction 402 within the second photonic propagation path 310b. As further shown in FIG. 4B, the first photonic signal 308a may be converted to a third photonic signal 308c propagating in the third propagation path 310c and the second photonic signal 308b may be converted to a fourth photonic signal 308d propagating in the fourth propagation path 310d.

FIG. 4C is side view of the photonic device 400 of FIG. 4A, according to various embodiments. The illustration of FIG. 4C corresponds to viewing the photonic device 400 along the positive y-axis (e.g., see FIG. 4A). As shown in FIG. 4C, the photonic coupler 304 may include a first angled reflector 314a that is configured to receive a first horizontally propagating photonic signal (i.e., the first photonic signal 308a) and to convert the first horizontally propagating photonic signal 308a into a vertically propagating photonic signal 318 that propagates within the first photonic via 307a. One or more additional angled reflectors (314b, 314c in FIG. 4D) may then convert the vertically propagating photonic signal 318 into one or more respective additional horizontally propagating photonic signals (308c, 308d) as described in greater detail with reference to FIG. 4D, below.

FIG. 4D is a further side view of the photonic device 400 of FIG. 4A, according to various embodiments. The illustration of FIG. 4D corresponds to viewing the photonic device 400 along the negative x-axis (e.g., see FIG. 4A). As shown in FIG. 4D, the photonic coupler 304 may include a second angled reflector 314b that may convert a first portion of the vertically propagating photonic signal 318 into a third horizontally propagating photonic signal (i.e., the first output signal 308c) that may then be provided to the third photonic propagation path 310c. Similarly, the photonic coupler 304 may include a third angled reflector 314c that may convert a second portion of the vertically propagating photonic signal 318 into a third horizontally propagating photonic signal (i.e., the second output signal 308d) that may then be provided to the third photonic propagation path 310c. In this regard, the photonic coupler includes a first photonic via 307a and a second photonic via 307b (e.g., see FIG. 4A). Just as the first photonic signal 308a is converted to a vertically propagating photonic signal 318 by the first angled reflector 314a, a similar vertically propagating photonic signal 318 may be generated from the second photonic signal 308b by the second photonic via 307b using an angled reflector (not shown) similar to the first angled reflector 314a.

In various embodiments, the angled reflectors (314a, 314b, 314c) may be formed at respective interfaces between the core portion 210 and the cladding material 212 (e.g., see FIG. 4A) and may act to reflect photonic signals due to the phenomena of total internal reflection. In other embodiments, one or more of the angled reflectors (314a, 314b, 314c) may further be formed of a metal layer (not shown) or a multi-layer dielectric structure (also not shown) including one of alternating Si/SiO₂ layers, alternating SiN/SiO₂ layers, or alternating Ta₂O₅/SiO₂ layers. As with other embodiments, described above, the first photonic propagation path 310a, the second photonic propagation path 310b, the third photonic propagation path 310c, the fourth photonic propagation path 310d, and the fifth propagation path 310e, may each be formed as a dielectric waveguide 200c (e.g., see FIG. 2C) having a core portion 210, having a first dielectric constant, surrounded by a cladding material 212 having a second dielectric constant that is less than the first dielectric constant.

In further embodiments, the photonic device 400 may include a photonic gain medium (not shown) located in the first photonic propagation path 310a and the second photonic propagation path 310b such that the photonic gain medium increases respective intensities of the first photonic signal 308a and the second photonic signal 308b. For example, the first photonic propagation path 310a and the second photonic propagation path 310b may be formed of a dielectric material that may be doped with erbium or other material that may exhibit optical fluorescent properties. In other embodiments, one or both of the first photonic via 307a and the second photonic via 307b may include a photonic gain medium.

The above-described embodiments include three-dimensional photonic interconnects (302a, 302b) that are formed as a multi-layer structure. In this regard, the photonic device 300 of FIGS. 3A to 3C may include a first photonic waveguide 310a formed within a first layer 212a of a cladding material 212 (e.g., see FIG. 3C). The first photonic waveguide 310a may have a first dielectric constant and the cladding material 212 may have a second dielectric constant that is less than the first dielectric constant. The photonic device 300 may further include a second photonic waveguide 310b formed within a second layer 212b of the cladding material 212. According to various embodiments, the second photonic waveguide 310b may have the first dielectric constant. As shown in FIG. 3C, for example, the second layer 212b of the cladding material 212 is vertically displaced relative to the first layer 212a of the cladding material 212. In this regard, the first layer 212a of the cladding material 212 may be formed over the first horizontal plane 306a and the second layer 212b of the cladding material 212 may be formed over the second horizontal plane 306b.

The photonic device 300 may further include a photonic via 307 formed within a third layer 212c of the cladding material 212. As shown in FIG. 3C, the third layer 212c of the cladding material 212 may separate the first layer 212a of the cladding material 212 and the second layer 212b of the cladding material 212. Further, as shown in FIG. 3A, the photonic via 307 photonically couples the first photonic waveguide 310a and the second photonic waveguide 310b. The photonic device 300 may further include a first angled reflector 314a (e.g., see FIG. 3C) that connects the first photonic waveguide 310a to the photonic via 307 and a second angled reflector 314b (e.g., see FIG. 3D) that connects the photonic via 307 to the second photonic waveguide 310b.

As shown in FIGS. 3C and 3D, the first angled reflector 314a may be configured to receive a first photonic signal 308a from the first photonic waveguide 310a and to convert the first photonic signal 308a into a vertically propagating photonic signal 318 within the photonic via 307. The second angled reflector 314b may be configured to receive the vertically propagating photonic signal 318 from the photonic via 307 and to convert the vertically propagating photonic signal 318 into a second photonic signal 308a1 that is provided to the second photonic waveguide 310b. In some embodiments, each of first angled reflector 314a and the second angled reflector 314b may include a metal layer (not shown) or a multi-layer dielectric structure (also not shown) having one of alternating Si/SiO₂ layers, alternating SiN/SiO₂ layers, or alternating Ta₂O₅/SiO₂ layers.

Referring to all drawings and according to various embodiments of the present disclosure, a photonic device 300 is provided. The photonic device 300 may include a first photonic interconnect 302a formed along a first direction (e.g., along the positive x-axis) over a first horizontal plane 306a and a second photonic interconnect 302b formed along a second direction (e.g., along the negative y-axis) over a second horizontal plane 306b that is vertically displaced relative to the first horizontal plane 306a, such that the first direction and the second direction are non-parallel. The photonic device 300 may further include a photonic coupler 304 connected to the first photonic interconnect 302a and the second photonic interconnect 302b. The photonic device 300 may be configured such that first photonic signals 308a that are incident on the photonic coupler 304 from the first photonic interconnect 302a are directed by the photonic coupler 304 into the second photonic interconnect 302b (e.g., as output signals 308a1 and 308a2). Further, the photonic device 300 may be configured such that second photonic signals (308b1, 308b2) that are incident on the photonic coupler 304 from the second photonic interconnect 302b are directed by the photonic coupler 304 into the first photonic interconnect 302a (e.g., as a single output signal 308b).

The photonic device 300 may further include a first angled reflector 314a (e.g., see FIG. 3C) that receives a first horizontally propagating photonic signal 308a and converts the first horizontally propagating photonic signal 308a into a vertically propagating photonic signal 318. The photonic device 300 may further include a second angled reflector 314b (e.g., see FIG. 3D) that converts the vertically propagating photonic signal 318 into a second horizontally propagating photonic signal 308a1. The first photonic interconnect 302a may include a first photonic propagation path 310a and the second photonic interconnect 302b may include a second photonic propagation path 310b. The first horizontally propagating photonic signal 308a may be received from the first photonic propagation path 310a by the photonic coupler 304 and the second horizontally propagating photonic signal 308a1 may be provided by the photonic coupler 304 to the second photonic propagation path 310b.

As shown in FIG. 3B, for example, the first photonic propagation path 310a may be oriented along the first direction (e.g., along the positive x-axis) and the second photonic propagation path 310b may be oriented along the second direction (e.g., along the negative y-axis). In various embodiments, the second direction may be oriented at a first angle that is between 0° and 180° relative to the first direction. The second photonic interconnect 302b further may include a third photonic propagation path 310c and the photonic coupler 304 further may include a third angled reflector 314c. As shown in FIG. 3D, for example, the third angled reflector 314c may convert a portion of the vertically propagating photonic signal 318 into a third horizontally propagating photonic signal 308a2 that may be provided to the third photonic propagation path 310c. In this regard, the first horizontally propagating photonic signal 308a may be split into the second horizontally propagating photonic signal 308a1 and the third horizontally propagating photonic signal 308a2.

As described above (e.g., see FIG. 3B) the first photonic propagation path 310a may be oriented along the first direction (e.g., along the positive x-axis), the second photonic propagation path 310b may be oriented along the second direction (e.g., along the negative y-axis), and the third photonic propagation path 310c may be oriented along a third direction (e.g., along the positive y-axis). As such, the second direction may be oriented at a first angle 312a that is approximately 90 ̊ and third direction may be oriented at a second angle 312b that is approximately 90°. In various other embodiments, the second direction may be oriented at a first angle 312a that is between 0° and 180° relative to the first direction and the third direction may be oriented at a second angle 312b that is between 0 ̊ and 180 ̊ relative to the first direction. In certain embodiments, the photonic coupler 304 further may include a photonic gain medium (not shown) that increases respective intensities of the second horizontally propagating photonic signal 308a1 and the third horizontally propagating photonic signal 308a2. In further embodiments, the first angled reflector 314a and the second angled reflector 314b may each include a metal layer or a multi-layer dielectric structure including one of alternating Si/SiO₂ layers, alternating SiN/SiO₂ layers, or alternating Ta₂O₅/SiO₂ layers.

As shown in FIGS. 3A to 3D, the photonic coupler 304 further may include a photonic via 307 that connects the first photonic interconnect 302a to the second photonic interconnect 302b such that the vertically propagating photonic signal 318 may be located within the photonic via 307. In various embodiments, the first photonic interconnect 302a and the second photonic interconnect 302b may each be formed as a dielectric waveguide (e.g., a silicon waveguide 200c) having a core portion 210, having a first dielectric constant, surrounded by a cladding material 212 having a second dielectric constant that may be less than the first dielectric constant. In various embodiments, the first photonic interconnect 302a and the second photonic interconnect 302b may be formed as silicon waveguides 200c having a silicon core portion 210 surrounded by a silicon oxide cladding material 212. In further embodiments, the first photonic interconnect 302a and the second photonic interconnect 302b may each be formed of one of Si, SiN, LiNbO₃, BaTiO₃, or a polymer material.

As illustrated in FIG. 4A, for example, a further photonic device 400 may include a first photonic interconnect 302a having a first photonic propagation path 310a and a second photonic propagation path 310b, a second photonic interconnect 302b having a third photonic propagation path 310c and a fourth photonic propagation path 310d, and a photonic coupler 304. The photonic coupler 304 may include a first photonic via 307a that connects the first photonic propagation path 310a to the third photonic propagation path 310c and a second photonic via 307b that connects the second photonic propagation path 310b to the fourth photonic propagation path 310d. The photonic coupler 304 may also include a first angled reflector 314a connecting the first photonic propagation path 310a and the first photonic via 307a and a second angled reflector 314b connecting the first photonic via 307a to the third photonic propagation path 310c. As further illustrated in FIG. 4C, the first photonic interconnect 302a may be formed over a first horizontal plane 306a and the second photonic interconnect 302b may be formed over a second horizontal plane 306b that may be vertically displaced relative to the first horizontal plane 306a.

According to various embodiments (e.g., see FIGS. 4A to 4C) the first photonic interconnect 302a may further include a fifth photonic propagation path 310e connected to the first photonic propagation path 310a and the second photonic propagation path 310b at a junction 402 such that an input photonic signal 308e propagating within the fifth photonic propagation path 310e toward the junction 402 may be split into a first photonic signal 308a propagating away from the junction 402 within the first photonic propagation path 310a and a second photonic signal 308b propagating away from the junction 402 within the second photonic propagation path 310b (e.g., see FIG. 4B).

In further embodiments, the photonic device 400 may include a photonic gain medium (not shown) located in the first photonic propagation path 310a and the second photonic propagation path 310b such that the photonic gain medium increases respective intensities of the first photonic signal 308a and the second photonic signal 308b. According to various embodiments, the first photonic propagation path 310a, the second photonic propagation path 310b, the third photonic propagation path 310c, and the fourth photonic propagation path 310d may each be formed as a dielectric waveguide (e.g., a silicon waveguide 200c) having a core portion 210, having a first dielectric constant, surrounded by a cladding material 212 having a second dielectric constant that is less than the first dielectric constant.

According to further embodiments, a photonic device 300 may include a first photonic waveguide 310a, having a first dielectric constant, formed within a first layer 212a of a cladding material 212, having a second dielectric constant, which may be less than the first dielectric constant (e.g., see FIG. 3C). The photonic device 300 may include a second photonic waveguide 310b, having the first dielectric constant, formed within a second layer 212b of the cladding material 212. As shown in FIG. 3C, the second layer 212b of the cladding material 212 may be vertically displaced relative to the first layer 212a of the cladding material 212. The photonic device 300 may further include a photonic via 307 formed within a third layer 212c of the cladding material 212 separating the first layer 212a of the cladding material 212 and the second layer 212b of the cladding material 212. Further, the photonic via 307 may photonically couple the first photonic waveguide 310a and the second photonic waveguide 310b.

The photonic device 300 may further include a first angled reflector 314a (e.g., see FIG. 3C) that connects the first photonic waveguide 310a to the photonic via 307 and a second angled reflector 314b (e.g., see FIG. 3D) that connects the photonic via 307 to the second photonic waveguide 310b. As shown in FIGS. 3C and 3D, the first angled reflector 314a may be configured to receive a first photonic signal 308afrom the first photonic waveguide 310a and to convert the first photonic signal 308a into a vertically propagating photonic signal 318 within the photonic via 307. The second angled reflector 314b may be configured to receive the vertically propagating photonic signal 318 from the photonic via 307 and to convert the vertically propagating photonic signal 318 into a second photonic signal 308a1 that is provided to the second photonic waveguide 310b. In some embodiments, each of first angled reflector 314aand the second angled reflector 314b may include a metal layer (not shown) or a multi-layer dielectric structure (also not shown) having one of alternating Si/SiO₂ layers, alternating SiN/SiO₂ layers, or alternating Ta₂O₅/SiO₂ layers.

Various embodiments disclosed herein may be advantageous by providing multi-directional, three-dimensional (3D), photonic interconnects. Such 3D photonic interconnects may allow photonic integrated circuits to be formed that have an increased integration density and may provide smaller devices with reduced optical insertion loss relative to systems that do not utilize 3D photonic interconnects.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A photonic device, comprising:
a first photonic interconnect comprising a first photonic propagation path formed along a first direction over a first horizontal plane;
a second photonic interconnect comprising a second photonic propagation path oriented along a second direction and a third photonic propagation path oriented along a third direction, wherein the second photonic interconnect is formed over a second horizontal plane that is vertically displaced relative to the first horizontal plane, and wherein the first direction and the second direction are non-parallel; and
a photonic coupler connected to the first photonic interconnect and the second photonic interconnect, the photonic coupler comprising:
a photonic via that connects the first photonic interconnect to the second photonic interconnect;
a first angled reflector configured to receive a first horizontally propagating photonic signal from the first photonic propagation path and to convert the first horizontally propagating photonic signal into a vertically propagating photonic signal within the photonic via;
a second angled reflector configured to receive the vertically propagating photonic signal from the photonic via and to convert the vertically propagating photonic signal into a second horizontally propagating photonic signal provided to the second photonic propagation path; and
a third angled reflector configured to convert a portion of the vertically propagating photonic signal into a third horizontally propagating photonic signal provided to the third photonic propagation path, such that the first horizontally propagating photonic signal is split into the second horizontally propagating photonic signal and the third horizontally propagating photonic signal.

2. The photonic device of claim 1, wherein the second direction is oriented at a first angle relative to the first direction, and wherein the first angle is between 0° and 180°.

3. The photonic device of claim 2, wherein the first angle is approximately 90°.

4. The photonic device of claim 1, wherein:
the first photonic interconnect comprises a first photonic propagation path oriented along the first direction;
the second photonic interconnect comprises a second photonic propagation path oriented along the second direction and a third photonic propagation path oriented along a third direction; and
the third direction is oriented at a second angle relative to the first direction, wherein the second angle is between 0° and 180°.

5. The photonic device of claim 4, wherein each of the second horizontally propagating photonic signal and the third horizontally propagating photonic signal has an intensity that is approximately half of an intensity of the first horizontally propagating photonic signal.

6. The photonic device of claim 1, wherein the second photonic propagation path and the third photonic propagation path extend in opposite directions from the photonic coupler along the second horizontal plane.

7. The photonic device of claim 6, wherein each of the first angled reflector and the second angled reflector comprises a planar surface that is angled relative to the first direction and a vertical direction perpendicular to the first horizontal plane.

8. The photonic device of claim 1, wherein the first photonic interconnect and the second photonic interconnect are each configured as a dielectric waveguide having a core portion with a first dielectric constant surrounded by a cladding material having a second dielectric constant that is less than the first dielectric constant, such that an optical mode propagating within the core portion has an electric field distribution that is confined to a localized region associated with the core portion.

9. A method of routing photonic signals in a photonic device, the method comprising:
receiving a first photonic signal propagating horizontally within a first photonic interconnect formed over a first horizontal plane;
converting, by a first angled reflector of a photonic coupler, the first photonic signal into a vertically propagating photonic signal within a photonic via of the photonic coupler;
converting, by a second angled reflector of the photonic coupler, the vertically propagating photonic signal into a second photonic signal propagating horizontally within a second photonic interconnect formed over a second horizontal plane that is vertically displaced relative to the first horizontal plane; and
directing the second photonic signal along a second direction within the second photonic interconnect, wherein the second direction is non-parallel to a first direction along which the first photonic signal propagates within the first photonic interconnect.

10. The method of claim 9, further comprising:
receiving a third photonic signal propagating horizontally within the second photonic interconnect;
converting, by the second angled reflector, the third photonic signal into a second vertically propagating photonic signal within the photonic via; and
converting, by the first angled reflector, the second vertically propagating photonic signal into a fourth photonic signal propagating horizontally within the first photonic interconnect.

11. The method of claim 9, further comprising:
splitting, by the photonic coupler, the vertically propagating photonic signal into the second photonic signal and a third photonic signal; and
directing the third photonic signal along a third direction within a third photonic propagation path of the second photonic interconnect, wherein the third direction is oriented at an angle relative to the first direction.

12. The method of claim 11, wherein the second direction is oriented at approximately 90° relative to the first direction and the third direction is oriented at approximately 90° relative to the first direction.

13. The method of claim 9, wherein the first photonic signal propagates within a core portion of the first photonic interconnect due to total internal reflection at an interface between the core portion and a cladding material surrounding the core portion.

14. The method of claim 9, further comprising:
receiving a third photonic signal propagating along the second direction within the second photonic interconnect;
receiving a fourth photonic signal propagating along a third direction within the second photonic interconnect;
combining, by the photonic coupler, the third photonic signal and the fourth photonic signal into a combined vertically propagating photonic signal within the photonic via; and
converting, by the first angled reflector, the combined vertically propagating photonic signal into a fifth photonic signal propagating along the first direction within the first photonic interconnect.

15. A method of routing photonic signals in a photonic device, the method comprising:
receiving an input photonic signal propagating within a fifth photonic propagation path of a first photonic interconnect formed over a first horizontal plane;
splitting, at a junction of the first photonic interconnect, the input photonic signal into a first photonic signal propagating within a first photonic propagation path and a second photonic signal propagating within a second photonic propagation path, wherein the first photonic propagation path and the second photonic propagation path are formed over the first horizontal plane;
converting, by a first photonic via of a photonic coupler, the first photonic signal into a third photonic signal propagating within a third photonic propagation path of a second photonic interconnect formed over a second horizontal plane that is vertically displaced relative to the first horizontal plane; and
converting, by a second photonic via of the photonic coupler, the second photonic signal into a fourth photonic signal propagating within a fourth photonic propagation path of the second photonic interconnect.

16. The method of claim 15, wherein converting the first photonic signal comprises:
receiving, by a first angled reflector, the first photonic signal propagating horizontally within the first photonic propagation path;
converting, by the first angled reflector, the first photonic signal into a first vertically propagating photonic signal within the first photonic via; and
converting, by a second angled reflector, the first vertically propagating photonic signal into the third photonic signal propagating horizontally within the third photonic propagation path.

17. The method of claim 15, wherein the first photonic propagation path and the second photonic propagation path are oriented at an angle relative to the fifth photonic propagation path.

18. The method of claim 15, wherein the first photonic signal propagates within a core portion of the first photonic propagation path, the core portion having a first dielectric constant and being surrounded by a cladding material having a second dielectric constant that is less than the first dielectric constant.

19. The method of claim 15, wherein the photonic device is formed on a silicon-on-insulator substrate comprising a silicon layer, an oxide layer formed over the silicon layer, and a silicon device layer formed over the oxide layer.

20. The method of claim 18, wherein the first photonic signal propagates within the core portion due to total internal reflection at an interface between the core portion and the cladding material.
